(19) United States
(12) Patent Application Publication
(10) Pub. No.: US 2022/0264250 A1
(43) Pub. Date: Aug. 18, 2022

(54) IP POSITIONING METHOD AND UNIT, COMPUTER STORAGE MEDIUM AND COMPUTING DEVICE

(71) Applicant: Beijing Digital Union Web Science and Technology Company Limited, Beijing (CN)

(72) Inventors: Congan Yang, Beijing (CN); Haiting Wang, Beijing (CN); Jingjing Liu, Beijing (CN)

(21) Appl. No.: 16/621,597

(22) PCT Filed: Nov. 15, 2019
(86) PCT No.: PCT/CN2019/118624

§ 371 Date: Dec. 11, 2019

(30) Foreign Application Priority Data
Nov. 4, 2019 (CN) 201911066449.7

(51) Int. Cl. H04W 4/029; H04L 69/08; G06K 9/62

(52) U.S. Cl. CPC H04W 4/029; G06K 9/6223; G06K 9/6272; H04L 69/08

(57) ABSTRACT

This invention provides an IP positioning method & unit, computer storage medium and computing device. The method includes collecting the plurality of GPS coordinates pointing to the same IP address and mapping them to one coordinate system; clustering the plurality of GPS coordinates based on the K-means clustering algorithm to acquire minimum one principal cluster circle, wherein, the GPS coordinates are the principal cluster objects of the principal cluster circles; selecting the principal cluster circle with the largest number of cluster objects as the target cluster circle; screening the target cluster object from the principal clustering objects in the target cluster circle based on the preset rules and taking the GPS coordinate of the target cluster object as the IP center coordinate of the IP address. Based on the scheme provided by this invention, we can eliminate the isolated GPS coordinate points far away, remove and filter the coordinates which are irrelevant and can generate interference, and make the IP center coordinates determined more realistic and accurate.

### TECHNICAL FIELD

This invention relates to the technical field of positioning, in particular to an IP positioning method and unit, a computer storage medium and a computing device.

### BACKGROUND ART

The Internet is the general name of the communication network which is made up of computers all over the world. When two computers on a network communicate with each other, they will contain some additional information in the packets they transmit. These additional information are actually the address of the computer sending data and the address of the computer receiving data. For the convenience of communication, people assign each computer an identification address similar to the telephone number in our daily life, which is the IP address.

The IP positioning technology is to determine the geographical position of a device through its IP address. The high-precision IP position calculation can conduct community granularity public opinion analysis on the behavior of people's network, so as to fully understand the public opinion and improve the network security defense ability. At present, in different scenarios of IP position such as neighborhoods and MAN enterprises, the central coordinate points are scattered and irregular, and the IP position accuracy is poor, which cannot meet the positioning requirements.

### CONTENTS OF THE INVENTION

One purpose of this invention is to overcome minimum one defect of the existing technology, and provide minimum one new IP positioning method and device, computer storage medium and computing device.

One further purpose of this invention is to effectively filter the interfering GPS coordinates.

The other further purpose of this invention is to make the IP center coordinate of the IP address more accurate.

In particular, according to one aspect of this invention, an IP positioning method is provided, including:

Collecting the plurality of GPS coordinates pointing to the same IP address, and mapping them to one coordinate system;

Clustering the GPS coordinates to obtain minimum one principal cluster circle based on the K-means clustering algorithm, wherein each GPS coordinate is the principal cluster object of the principal cluster circle;

Selecting the principal cluster circle containing the largest number of the principal cluster objects as the target cluster circle;

Selecting the target cluster object from the principal cluster objects included in the target cluster circle based on the preset rules, and taking the GPS coordinate of the target cluster object as the IP center coordinate of the IP address.

Optionally, selecting the target cluster object from the principal cluster objects included in the target cluster circle based on the preset rules, it includes:

Calculating the mutual distances respectively between the principal cluster objects in the target cluster circle in the coordinate system, and select the principal distance and the secondary distance in sequence from the smallest to the largest;

Acquiring a plurality of principal cluster objects generating the principal distance and the secondary distance as a plurality of screening objects;

Selecting the target cluster object from the plurality of screening objects.

Optionally, selecting the target cluster object from the plurality of screening objects, it includes:

Judging whether there is the same screening object between the two principal screening objects generating the principal distance and the two secondary screening objects generating the secondary distance;

If yes, determining the same screening object is the target cluster object.

Optionally, if not, determining the midpoint of the two secondary screening objects, and selecting the screening object with the shortest distance to the midpoint as the target cluster object from the two principal screening objects corresponding to the principal distance.

Determining the midpoint between the two secondary screening targets, it includes:

Taking the point between the two screening objects generating the secondary distance as the midpoint.

Optionally, collecting the plurality of GPS coordinates pointing to the same IP address, and mapping them to one coordinate system, it also includes:

Judging whether the number of GPS coordinates is greater than the preset threshold;

If yes, randomly extracting the target GPS coordinates of the preset threshold value from the plurality of GPS coordinates;

Clustering the target GPS coordinates to obtain minimum one secondary cluster circle, wherein each target GPS coordinate is the secondary cluster object of the secondary cluster circle;

Selecting the secondary cluster circle which contains the largest number of the secondary cluster objects as the source cluster circle.

Optionally, clustering the GPS coordinates based on the K-means clustering algorithm and obtaining minimum one principal cluster circle, it includes:

Clustering the secondary cluster objects included in the source cluster circle based on the K-means clustering algorithm to obtain minimum one principal cluster circle, wherein each secondary cluster object belonging to the source cluster circle is the principal cluster object of the principal cluster circle.

According to another aspect of this invention, an IP positioning method device is provided, including:

Collection module: for collecting the plurality of GPS coordinates pointing to the same IP address, and mapping them to one coordinate system;

Clustering module: for clustering the plurality of GPS coordinates based on K-means clustering algorithm and obtaining minimum one principal cluster circle, wherein each GPS coordinate is the principal cluster object of the principal cluster circle;

Selection module: for selecting the principal cluster circle containing the largest number of the principal cluster objects as the target cluster circle;

Screening module: for selecting the target cluster object from the principal cluster objects included in the target cluster circle based on the preset rules, and taking the GPS coordinate of the target cluster object as the IP center coordinate of the IP address.

According to another aspect of this invention, a computer storage medium is provided which stores computer program code. When the computer program code runs on the computing device, the computing device will execute any of the IP positioning methods mentioned above.

According to another aspect of this invention, a computing device is provided, including: Processor;

Memory with computer program code;

When the computer program code is operated by the processor, the computing device will execute any of the IP positioning methods mentioned above.

This invention provides a more accurate IP positioning method and unit which will map the collected GPS coordinates to one coordinate system, and cluster the plurality of GPS coordinates based on the K-means clustering algorithm so as to acquire the target cluster circles with the largest number of principal cluster objects, select the target cluster object from the target cluster circles and take the GPS coordinate of this target cluster object as the center coordinate of the IP address. To acquire the principal cluster circles through the K-means clustering algorithm based on the methods provided by the embodiments of this invention and select the cluster circle with the largest number of the cluster objects from the plurality of principal cluster circles as the cluster circle most likely to generate the IP center coordinate can exclude the isolated GPS coordinate points with a long distance, and realize the removal and filtering of irrelevant and interfering coordinate information.

Furthermore, the methods provided by this invention will not take the center point of the cluster circle as the IP center coordinate, but select the target cluster object from the target cluster circle, and then take the GPS coordinate of the target cluster object as the IP center coordinate of the IP address, so that the determined IP center coordinate is more realistic and accurate.

By elaborating the embodiments of this invention according to the text below and combined with the figures, the technicians of this field will be more aware of the purposes, advantages and features of this invention above mentioned or not

### BRIEF DESCRIPTION OF THE DRAWINGS

Certain embodiments of this invention will be described in detail below in an exemplary rather than restrictive manner with reference to the figures. The same or similar parts are indicated with the same marks in the figures. The technicians of this field shall understand that these figures may not be made as scale. In the figures:

FIG. 1 is the flowchart of the IP positioning method of an embodiment of this invention;

FIG. 2 is the schematic diagram of the target cluster object of an embodiment of this invention;

FIG. 3 is the schematic diagram of the target cluster object of another embodiment of this invention;

FIG. 4 is the flowchart of the IP positioning method of another embodiment of this invention;

FIG. 5 is the structural diagram of the IP positioning device of an embodiment of this invention;

FIG. 6 is the structural diagram of the IP positioning device of another embodiment of this invention.

### EMBODIMENTS

The exemplary embodiments of this invention will be described in detail below with reference to the figures. Although the exemplary embodiments of this invention are shown in the figures, it shall be understood that this invention may be realized in various forms rather than be limited by the embodiments described herein. On the contrary, these embodiments are provided for better understanding of this invention and for transmitting the scope of this invention to the technicians of this field completely.

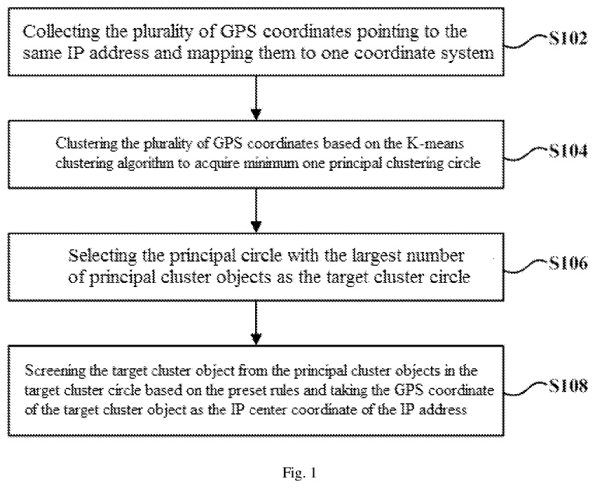

FIG. 1 is the flowchart of the IP positioning method of an embodiment of this invention. As shown in FIG. 1, the IP positioning method provided by the embodiments of this invention can include:

Step S102: Collecting the plurality of GPS coordinates pointing to the same IP address, and mapping them to one coordinate system;

Step S104: Clustering the GPS coordinates to obtain minimum one principal cluster circle based on the K-means clustering algorithm, wherein each GPS coordinate is the principal cluster object of the principal cluster circle;

Step S106: Selecting the principal cluster circle containing the largest number of the principal cluster objects as the target cluster circle;

Step S108: Selecting the target cluster object from the principal cluster objects included in the target cluster circle based on the preset rules, and taking the GPS coordinate of the target cluster object as the IP center coordinate of the IP address.

This invention provides a more accurate IP positioning method and unit which will map the collected GPS coordinates to one coordinate system, and cluster the plurality of GPS coordinates based on the K-means clustering algorithm so as to acquire the target cluster circles with the largest number of principal cluster objects, select the target cluster object from the target cluster circles and take the GPS coordinate of this target cluster object as the center coordinate of the IP address. To acquire the principal cluster circles through the K-means clustering algorithm based on the methods provided by the embodiments of this invention and select the cluster circle with the largest number of the cluster objects from the plurality of principal cluster circles as the cluster circle most likely to generate the IP center coordinate can exclude the isolated GPS coordinate points with a long distance, and realize the removal and filtering of irrelevant and interfering coordinate information. In addition, the methods provided by this invention will not take the center point of the cluster circle as the IP center coordinate, but select the target cluster object from the target cluster circle, and then take the GPS coordinate of the target cluster object as the IP center coordinate of the IP address, so that the determined IP center coordinate is more realistic and accurate.

In general, there may be a plurality of GPS (Global Positioning System) coordinates pointing to the IP address of the same geographical position. Therefore, a large number of data bases can be provided by collecting a plurality of GPS coordinates as the IP center coordinate to determine the IP address. Thereof, the collected GPS coordinates can point to all the existing GPS coordinates of the same IP address, or the GPS coordinates larger than a certain frequency value, which is not limited by this invention. GPS coordinates are generally composed of two parameters i.e. longitude and latitude. After a plurality of GPS coordinates are collected, they can be mapped to one coordinate system such as the coordinate system preset based on longitude and latitude for the subsequent K-means clustering algorithm.

As mentioned in the Step S104 above, a plurality of GPS coordinates may be clustered to acquire minimum one principal cluster circle. K-means clustering algorithm is an iterative clustering analysis algorithm with the steps to randomly select K objects as the initial clustering center, then calculate the distance between each object and each seed clustering center, and assign each object to the nearest clustering center. The clustering centers and objects assigned can represent a cluster. Whenever a sample is allocated, a clustering center will be recalculated according to the existing objects in the cluster. This process will be repeated until a termination condition is reached. The termination condition can be that no (or the smallest number of) objects are reassigned to different clusters, no (or the smallest number of) cluster centers change again, and the sum of error squares is locally minimum. In addition, when an IP comes from different terminal devices, the reports of different time ranges will have a plurality of GPS coordinates. These coordinates will be represented by the pattern of circular (in most cases) or irregular graphics (in a few cases) on the map, and then these circular or irregular graphics can be called cluster circles.

In this embodiment, the K-means clustering algorithm can reasonably classify the GPS system coordinates, thus providing a basis for the subsequent selection of target cluster circle that may have IP center coordinate. The number of the principal cluster circle generated based on the K-means clustering algorithm, that is, the K value in the K-means clustering algorithm can be set according to different requirements (e.g. 2, 5 or other natural numbers), which is not limited in this invention. Thereof, each GPS coordinate is the principal cluster object in each principal cluster circle.

Furthermore, after acquiring minimum one principal cluster circle, the principal cluster circle with the largest number of principal cluster objects can be selected as the principal cluster circle. As mentioned in Step S104 above, minimum one principal cluster circle can be acquired based on the K-means clustering algorithm. Therefore, in practical application, when the number of the principal cluster circle is one, the principal cluster circle can be taken as the target cluster circle directly. When the number of the principal cluster circles is more, the principal cluster circle containing the largest number of principal cluster objects can be chosen as the target cluster circle, so as to effectively determine the cluster circle which is most likely to generate IP center coordinate.

As mentioned in the Step S108 above, the target cluster object can be selected from the principal cluster objects included in the target cluster circle based on the preset rules, so that the GPS coordinates of the target cluster object are taken as the IP center coordinate of the IP address. Since the target cluster circle may include a plurality of principal cluster objects, it is necessary to select the target cluster object to determine the IP center coordinate of the IP address.

In an optional embodiment of this invention, when the Step S108 above determines the target cluster object based on the preset rules, it can include:

1. Calculating the mutual distances respectively between the principal cluster objects in the target cluster circle in the coordinate system, and select the principal distance and the secondary distance in order from the smallest to the largest. That is, for each principal cluster object in the target cluster circle, the distance between one principal cluster object and another principal cluster object is calculated, and all the calculated mutual distances are sorted. We may sort from the smallest to the largest, or from the largest to the smallest based on the distance. Finally, we may select the principal distance and the secondary distance in order from the smallest to the largest that is, select the smallest distance and the second smallest distance.

2. Taking the plurality of principal cluster objects generating the principal distance and the secondary distance as the plurality of screening objects. Since the distance is taken from two principal distance objects, after selecting the principal distance and the secondary distance, two principal cluster objects that generate the principal distance and two principal cluster objects that generate the secondary distance (four cluster objects) can be acquired. For example, supposed that the principal distance is the distance between the principal cluster objects A and B, and the secondary distance is the distance between the principal cluster objects C and D, it is necessary to acquire the principal cluster objects A, B, C and D, and take the above four principal cluster objects as the screening objects. In addition, the cluster objects A and B are the principal screening objects to generate the principal distance, and the cluster objects C and D are the secondary screening objects to generate the secondary distance.

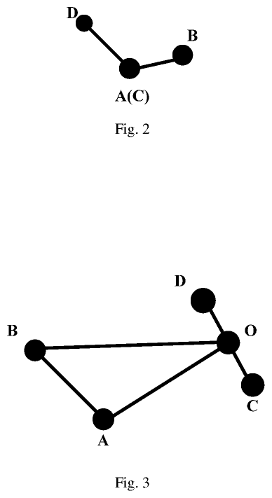

3. Selecting the target cluster object from the plurality of screening objects. That is, selecting one of the above-mentioned screening objects A, B, C and D as the target cluster object. Optionally, when selecting the target cluster objects from the plurality of screening objects, we can firstly determine whether there is the same screening object between the two principal objects generating the principal distance and the two secondary screening objects generating the secondary distance; if yes, the same screening object is determined as the target cluster object; if not, we shall determine the midpoint of the two screening objects and take screening object with the smallest distance from the midpoint from the two principal screening objects corresponding to the principal distance as the target cluster object. We can judge whether the same screening object exists in the screening objects A, B and C, D by taking the screening objects A, B, C and D in the above embodiment as examples, that is, whether A is the same as C or D, or whether B is the same as C or D. As shown in FIG. 2, supposed A is the same as C, we shall take A (or C) as the target cluster object and then the GPS coordinate corresponding to A (or C) will be the IP center coordinate. As shown in FIG. 3, supposed the screening objects A, B, C and D are different from each other, we shall determine the midpoint of A, B, C and D and then select the screening object A/C closest to the midpoint as the target cluster object.

The midpoint refers to the point with the smallest distance to the vertices of the graph. For example, the midpoint of a line segment is any point between the ends of the line segment (including the ends of the line segment), the midpoint of a convex quadrilateral is the intersection of its diagonals, and the midpoint of a convex polygon is the intersection of all the diagonals that intersect in sequence. In this embodiment, when determining the midpoint, the midpoint of the two secondary screening objects generating the secondary distance can be used as the midpoint of the plurality of the screening objects. That is to say, as shown in FIG. 3, we can firstly establish a line segment based on C and D and determine the midpoint of the line segment CD as the midpoint of the plurality of screening objects. That is, take the point O in the middle of the line segment as the midpoint. We can calculate the distance between A/B and O based on their longitude and latitude. Wherein, supposed the longitude and latitude of C are respectively represented by lngC and latC and those of D by lngD and latD, the longitude and latitude of the midpoint O will be respectively (lngC+lngD)/2 and (latC+latD)/2. In the embodiment shown by FIG. 3, the cluster object A can be taken as the target cluster object and the GPS coordinate corresponding to A will be the IP center coordinate of the IP address.

Sometimes the excessive number of GPS coordinates of one IP address may occur and bring pressure to the subsequent process of determining the target cluster object. Optionally, before the Step S102, we can judge whether the number of GPS coordinates is greater than the preset threshold; if yes, randomly extract the target GPS coordinate of the preset threshold from the plurality of GPS coordinates; cluster the target GPS coordinate based on K-means clustering algorithm and acquire minimum one secondary cluster circle; wherein, the target GPS coordinate is the secondary cluster object of the secondary cluster circle; the secondary cluster circle with the largest number of cluster objects can be selected as the source cluster circle.

In this embodiment, if the collected GPS coordinate is greater than the preset threshold, we can clear the GPS coordinate collected firstly. In detail, we may cluster by the K-means clustering algorithm to form minimum one secondary cluster circle and take the target GPS coordinate as the secondary cluster object of the secondary cluster circle so as to take the secondary cluster circle with the largest number of the secondary cluster objects as the source cluster circle. Optionally, the number of the secondary cluster circles can be greater than that of the principal cluster circles so as to improve the precision of the target cluster objects. Thereof, the preset threshold can be set according to different precisions, which is not limited in this invention.

Furthermore, after selecting the source cluster objects, we can take all the secondary cluster objects among the source cluster objects as the cluster objects of K-means cluster algorithm in the Step S104. That is, the Step S104 can also include: clustering the secondary cluster objects contained in the source clustering circle based on the K-means clustering algorithm to acquire minimum one principal cluster circle; wherein, each secondary cluster object belonging to the source clustering circle is the principal cluster object of the principal cluster circle. To take the secondary cluster circle with the largest number of cluster objects acquired from the principal clustering as the foundation of the secondary clustering can effectively remove and filter the unqualified GPS coordinates, get the real cluster circles, select the target cluster object fast and determine the IP center coordinate exactly.

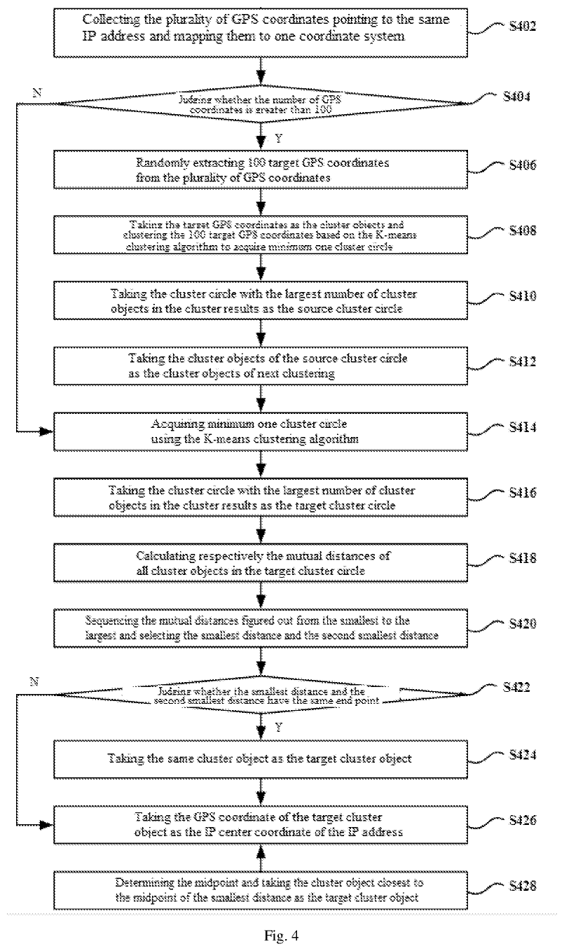

FIG. 4 is the flowchart of the IP positioning method of another embodiment of this invention. With reference to FIG. 4, we can see the IP positioning method provided by the embodiment of this invention can include:

Step S402: collecting a plurality of GPS coordinates pointing to the same IP address, and mapping them to one coordinate system;

Step S404: judging whether the number of GPS coordinates is greater than 100, if yes, execute

Step S406; if not, take the plurality of GPS coordinates as cluster objects for the subsequent K-means clustering algorithm, and execute Step S414;

Step S406: we can randomly select 100 GPS coordinates from the plurality of GPS coordinates, avoiding the pressure of large amount of data calculation on subsequent calculation. When sampling, we can list all GPS coordinates, and then randomly select coordinates from the list, so that the number of selected GPS coordinates can reach 100;

Step S408: taking the target GPS coordinates as the cluster objects and cluster the 100 target GPS coordinates based on K-means clustering algorithm to acquire minimum one cluster circle; wherein, K=5;

Step S410: taking the cluster circle with the largest number of cluster objects in the cluster results as the source cluster circle; this step can eliminate the isolated points far away and prevent the calculation of the center of cluster circles from the interference of certain coordinates, mainly the isolated points or cluster circles at edges or far away from cluster circles;

Step S412: taking the cluster objects in the source cluster circles as the cluster objects for next clustering;

Step S414: using the K-means clustering algorithm to acquire minimum one cluster circle; wherein, K=2;

Step S416: taking the cluster circle with the largest number of cluster objects in the cluster results as the target cluster circle;

Step S418: calculating respectively the mutual distances of all cluster objects in the target cluster circle;

Step S420: sequencing the mutual distances figured out from the smallest to the largest and selecting the smallest distance and the second smallest distance; wherein, the smallest distance is corresponding to the cluster objects X and Y and the second smallest distance is corresponding to the cluster objects M and N;

Step S422: judging whether the smallest distance and the second smallest distance have the same end point; that is, judging whether the cluster object X or Y is the same as the cluster object M or N; if yes, execute the Step S424; if not, execute the Step S428;

Step S424: taking the same cluster object as the target cluster object;

Step S426: taking the GPS coordinate of the target cluster object as the IP center coordinate of the IP address;

Step S428: determining the midpoint and taking the cluster object closest to the midpoint in the smallest distance as the target cluster object; that is, take the cluster object X or Y closest to the midpoint as the target cluster object.

The scheme provided by the embodiment of this invention can effectively identify the accuracy and reality of the IP reports with the coordinate information delivered from the terminals through screening, filtering, selecting and calculating the midpoint, acquire the most potential real coordinate point (the midpoint of the non-scattered circle as actual verification) of the IP exactly and realize the accurate positioning of IP.

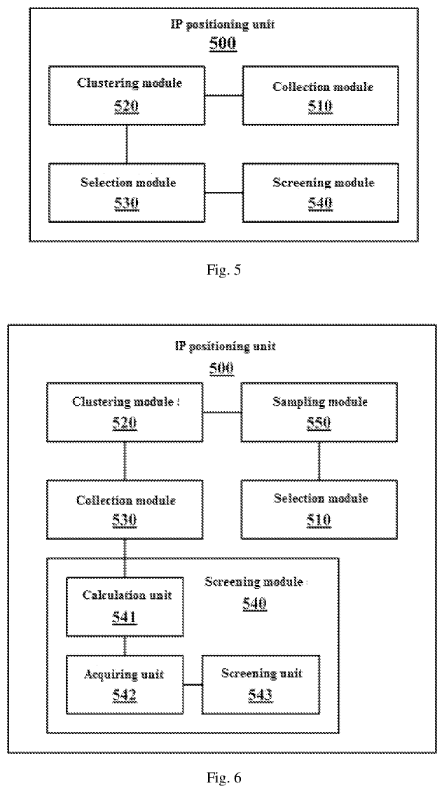

The embodiment of this invention also provides the IP positioning method unit 500 based on the invention conception. As shown in FIG. 5, the IP positioning method unit 500 provided by the embodiment can include:

Collection module 510: for collecting to the plurality of GPS coordinates pointing to the same IP address and mapping them to one coordinate system;

Clustering module 520: for clustering the plurality of GPS coordinates based on the K-means clustering algorithm to acquire minimum one cluster circle; wherein, all GPS coordinates will be the principal cluster objects of the principal cluster circles;

Selection module 530: for selecting the principal cluster circle with the largest number of principal cluster objects as the target cluster circle;

Screening module 540: for screening the target cluster object from the principal cluster objects in the target cluster circles based on the preset rules and taking the GPS coordinate of the target cluster object as the IP center coordinate of the IP address.

In an optional embodiment of this invention, as shown in FIG. 6, the screening module 540 can include:

Calculation unit 541: for calculating respectively the mutual distances of all principal cluster objects in target cluster circles as the coordinate system and selecting the principal distance and the secondary distance as the sequence from the smallest to the largest;

Acquisition unit 542: for acquiring the plurality of principal cluster objects generating the principal distance and the secondary distance as the plurality of screening objects;

Screening unit 543: for screening the target cluster object from the plurality of screening objects.

In an optional embodiment of this invention, the screening unit 543 can also be for: Judging whether the two principal screening objects generating the principal distance and the two secondary screening objects generating the secondary distance have the same screening target;

When the same screening object exists, determining it as the target cluster object.

In an optional embodiment of this invention, the screening unit 543 can also be for:

When the same screening object doesn't exist, determining the midpoint of the two secondary screening objects and selecting the screening object with the smallest distance to the midpoint from the two principal screening objects corresponding to the principal distance as the target cluster object.

In an optional embodiment of this invention, the screening unit 543 can also be for: taking the point in the middle of the distance between the two secondary screening objects as the midpoint. In an optional embodiment of this invention, as shown in FIG. 6, the IP positioning method unit 500 can also include the sampling module 550, which is for:

Judging whether the number of GPS coordinates is greater than the preset threshold;

If yes, randomly extracting the target GPS coordinates of the preset threshold from the plurality of GPS coordinates;

Clustering the target GPS coordinates based on the K-means clustering algorithm to acquire minimum one secondary cluster circle; wherein, the target GPS coordinates will be the secondary cluster objects of the secondary cluster circles;

Selecting the secondary cluster circle with the largest number of the secondary cluster objects as the source cluster circle.

In an optional embodiment of this invention, the clustering module 520 can be also for:

Clustering the secondary cluster objects in the source cluster circle based on the K-means clustering algorithm to acquire minimum one principal cluster circle; wherein, the secondary cluster objects belonging to the source cluster circle will be the principal cluster objects of the principal cluster circles.

Based on the conception of the invention, the embodiment of this invention also provides a computer storage medium with computer program code. When the computer program code runs on the computing device, the computing device will execute the IP positioning method in any of the embodiments mentioned above.

Based on the conception of the invention, the embodiment of this invention also provides a computer device, including:

Professor;

Memory with computer program code;

When the computer program code is operated by the processor, the computing device will execute any of the IP positioning methods mentioned above.

The embodiment of this invention provides a more accurate IP positioning method and unit which will map the collected GPS coordinates to one coordinate system, and cluster the plurality of GPS coordinates based on the K-means clustering algorithm so as to acquire the target cluster circles with the largest number of principal cluster objects, select the target cluster object from the target cluster circles and take the GPS coordinate of this target cluster object as the center coordinate of the IP address. To acquire the principal cluster circles through the K-means clustering algorithm based on the method provided by the embodiment of this invention and select the cluster circle with the largest number of the cluster objects from the plurality of principal cluster circles as the cluster circle most likely to generate the IP center coordinate can exclude the isolated GPS coordinate points with a long distance, and realize the removal and filtering of irrelevant and interfering coordinate information. In addition, the methods provided by this invention will not take the center point of the cluster circle as the IP center coordinate, but select the target cluster object from the target cluster circle, and then take the GPS coordinate of the target cluster object as the IP center coordinate of the IP address, so that the determined IP center coordinate is more realistic and accurate.

Furthermore, the scheme provided by the embodiment of this invention can maximize the filtering of the interfering coordinates through secondary clustering and improve the precision, and can replace the original fuzzy value with the accurate value through taking the GPS coordinate of the target cluster object as the IP center coordinate.

In addition, the scheme provided by the embodiments of this invention can be used to solve the excessive differences of IP precision in neighborhoods, MAN, enterprises and other scenarios, and overcome the poor positioning precision, the plurality of cluster circles and other complex issues resulted from scattered and irregular coordinate points to a large extent by describing/allocating the difference precisions of IP, calculating the radius and selecting the midpoints in different scenarios.

The technicians of this field can be clear of the specific work process of the systems, devices and units mentioned above with reference to the aforesaid embodiments of methods, which will not be described herein for the sake of brevity.

In addition, the functional units in the embodiments of this invention can be physically independent or be integrated each two or more, or integrated into one processing unit. The aforesaid functional units can be realized through hardware or software/firmware.

The common technicians of this field can understand that: when an integrated functional unit is realized through software and sold or used as an independent product, it can be stored in a computer readable storage medium. Therefore, the technical scheme of this invention can be represented by software product in essence or partially. The computer software product is stored in a storage medium and with several instructions, it can make a computing device (e.g. personal computer, server, or network device) execute all or part of steps of the method in the embodiments of this invention when operating the instructions. The aforesaid storage medium includes U disk, mobile hard disk, ROM, RAM, CD and other media which can store program codes.

All or part of the steps of the embodiments realizing the aforesaid method can be completed through relevant hardware of program instructions (e.g. personal computer, server, network device and other computing device). The program instructions can be stored in a computer readable storage medium. When the program instructions are executed by the processor of the computing device, the computing device can execute all or part of the steps of the method of all embodiments.

The technicians of this field shall understand that though this paper has elaborated multiple demonstrative embodiments, many variations or changes complied with the invention principles can also be directly determined or inferred according to the disclosed contents of this invention based on the spirit and scope of this invention. Therefore, the scope of this invention shall be understood and recognized as it has covered all these variations or changes.

We claim:

1. An IP positioning method, including:
collecting the plurality of GPS coordinates pointing to the same IP address, and mapping them to one coordinate system;
clustering the GPS coordinates to obtain minimum one principal cluster circle based on the K-means clustering algorithm, wherein each GPS coordinate is the principal cluster object of the principal cluster circle;
selecting the principal cluster circle containing the largest number of the principal cluster objects as the target cluster circle;
selecting the target cluster object from the principal cluster objects included in the target cluster circle based on the preset rules, and taking the GPS coordinate of the target cluster object as the IP center coordinate of the IP address.

2. According to the method in claim 1, which featured selecting the target cluster object from the principal cluster objects included in the target cluster circle based on the preset rules, it includes:
calculating the mutual distances respectively between the principal cluster objects in the target cluster circle in the coordinate system, and select the principal distance and the secondary distance in sequence from the smallest to the largest;
acquiring a plurality of principal cluster objects generating the principal distance and the secondary distance as a plurality of screening objects;
selecting the target cluster object from the plurality of screening objects.

3. According to the method in claim 2 which featured selecting the target cluster object from the plurality of screening objects, it includes:
judging whether there is the same screening object between the two principal screening objects generating the principal distance and the two secondary screening objects generating the secondary distance;
if yes, determining the same screening object is the target cluster object.

4. According to the method in claim 3 which featured determining whether there is the same screening object between the two principal objects generating the principal distance and the two secondary screening objects generating the secondary distance, it also includes:
if not, determining the midpoint of the two secondary screening objects, and selecting the screening object with the shortest distance to the midpoint as the target cluster object from the two principal screening objects corresponding to the principal distance.

5. According to the method in claim 4 which featured determining the midpoint between the two secondary screening targets, it includes:
taking the point in the middle of the distance between the two screening objects generating the secondary distance as the midpoint.

6. According to the method described in claim 1, which featured collecting the plurality of GPS coordinates pointing to the same IP address, and mapping them to one coordinate system, it also includes:
judging whether the number of GPS coordinates is greater than the preset threshold;
if yes, randomly extracting the target GPS coordinates of the preset threshold value from the plurality of GPS coordinates;
clustering the target GPS coordinates to obtain minimum one secondary cluster circle, wherein each target GPS coordinate is the secondary cluster object of the secondary cluster circle;
selecting the secondary cluster circle which contains the largest number of the secondary cluster objects as the source cluster circle.

7. According to the method in claim 6 which featured clustering the plurality of GPS coordinates based on the K-means clustering algorithm and obtaining minimum one principal cluster circle, it includes:
clustering the secondary cluster objects included in the source cluster circle based on the K-means clustering algorithm to obtain minimum one principal cluster circle, wherein each secondary cluster object belonging to the source cluster circle is the principal cluster object of the principal cluster circle.

8. An IP positioning method device, including:
collection module: for collecting the plurality of GPS coordinates pointing to the same IP address, and mapping the plurality of GPS coordinates to one coordinate system;
clustering module: for clustering the plurality of GPS coordinates based on K-means clustering algorithm and obtaining minimum one principal cluster circle, wherein each GPS coordinate is the principal cluster object of the principal cluster circle;
selection module: for selecting the principal cluster circle containing the largest number of the principal cluster objects as the target cluster circle;
screening module: for selecting the target cluster object from the principal cluster objects included in the target cluster circle based on the preset rules, and taking the GPS coordinate of the target cluster object as the IP center coordinate of the IP address.

9. (canceled)

10. (canceled)
